(19) United States
(12) Patent Application Publication
(10) Pub. No.: US 2016/0283667 A1
(43) Pub. Date: Sep. 29, 2016

(54) SYSTEMS AND METHODS FOR PROVIDING MERGED MEDICAL INFORMATION FOR A PATIENT

(71) Applicant: Health Portal LLC, Addison, TX (US)

(72) Inventors: Jyothsna RACHAPALLI, Richardson, TX (US); Vaibhav KHADILKAR, Dallas, TX (US)

(73) Assignee: HEALTH PORTAL LLC.

(21) Appl. No.: 15/080,118

(22) Filed: Mar. 24, 2016

Related U.S. Application Data
(60) Provisional application No. 62/139,142, filed on Mar. 27, 2015.

(51) Int. Cl. G06F 19/00; H04L 29/06

(52) U.S. Cl. CPC G06F 19/322; H04L 63/10

(57) ABSTRACT

A system for merging medical information for a patient whose medical records are stored in one or more locations, is described. The system comprises one or more storage media storing computer readable instructions; and one or more processors configured to execute the instructions to cause the system to: retrieve at least one medical record with sections from at least one database and associate the sections with at least one body part and at least one medical condition pertaining to the body part; receive a body part selection and a medical condition selection from a patient's system, and provide the patient with a copy of merged medical documents comprising the sections pertaining to the selected body part and the selected medical condition. In some embodiments, the body part selection is aided by use of a body image.

### CROSS-REFERENCE TO RELATED APPLICATIONS

This application claims the benefit of U.S. Provisional Application Ser. No. 62/139,142, filed Mar. 27, 2015, which is hereby incorporated by reference in its entirety.

### BACKGROUND

The advent of electronic health records (EHRs) has improved the exchange of health information. Where before a healthcare provider or patient needed to request, wait for, and receive a hardcopy of medical records by fax or a postal service, the healthcare provider or patient may now receive electronic copies of medical health records nearly instantly by electronic mail or by accessing them over a computer network on a server. An increase in patient and healthcare-provider access to medical information facilitates better patient care by putting it in the hands of providers when they need it most.

Various health organizations, such as the Office of the National Coordinator for Health Information Technology (ONC) operating under the United States Department of Health and Human Services (HHS), are attempting to create and influence Health Information Technology (Health IT) infrastructures that will manage and facilitate EHR access to providers and patients. One of the standards that the ONC included in the regulations for 2014 EHR Certification was the Health Level Seven (HL7) Implementation Guide for CDA Release 2: IHE Health Story Consolidation. The HL7 “consolidated” clinical-document architecture (CDA) standard contains a library of CDA-template standards and represents a single, unified implementation guide for multiple electronic clinical documents.

Most patients, however, do not have the requisite Health IT hardware and software systems or expertise necessary to access their HL7-compliant medical records from their healthcare provider's databases. Many patients may also be discouraged from accessing their medical records because the records are stored in numerous different databases, each database hosted by a different healthcare provider that requires his or her own method of access. Additionally, many patients, upon getting access to their EHRs, may be unable to get meaningful information from the EHRs because the provider prepared the EHRs in a manner such that they are understandable to the provider rather than understandable to the patient. These problems pose unique challenges to EHRs within Health IT infrastructures because EHRs are often needed in emergency-care scenarios where one does not have time to get the necessary hardware, software, and experience to access EHRs on a remote healthcare provider's database. These problems also pose unique challenges to EHRs within Health IT infrastructures because a patient may have tens or, in some cases, hundreds of different healthcare providers over the course of their lifetime, and EHRs could be generated at each of these points of service; a patient may need to spend hours or days accessing each provider's database to find the particular collection of EHRs he or she is looking for. Even if a patient did get access to the EHRs they sought, determining which sections of the EHRs pertain to the specific condition or ailment of interest to the patient may be challenging because acquiring medical knowledge and understanding medical jargon is time-consuming, expensive, and difficult. One or more embodiments of the disclosed systems provide a solution to these problems.

Because electronic health information exchange relies primarily on Internet services and communication of highly sophisticated information that is often needed urgently and collected from hundreds of locations, the challenges of providing EHR access to patients without medical knowledge quickly and easily are unique to the field of Internet-based Health IT. Likewise, the solutions that may have worked for similar, but notably distinct, problems in non-Internet-based Health IT services are not practical or effective for Internet-based Health IT services. For example, a non-Internet-based service may alleviate the lack of medical expertise most patients have by sending an explanatory note with a hardcopy of a medical record. Doing so for an Internet-based service would be unworkable because requiring someone from the provider's office to participate in the information transfer would obviate one of the primary reasons for using an Internet-based service: to have a single-user solution (i.e., a patient requesting the EHR may do so quickly without waiting for participation by the provider who previously uploaded the EHR into his or her database). Therefore, a solution to the problem for non-Internet services does not work for Internet services, and another solution is required to allow patients effective EHR access.

### SUMMARY

The present disclosure is directed to systems and methods for merging medical information for a patient.

Consistent with at least one disclosed embodiment, a system is disclosed for providing merged medical information for a patient whose medical records are stored in one or more locations. In one embodiment this may be accomplished with one or more storage media storing computer readable instructions; and one or more processors configured to execute the instructions to cause the system to: receive authorization to access at least one medical record associated with a patient; retrieve, based on the authorization, the at least one medical record from at least one database, wherein the at least one medical record comprises one or more sections; associate the one or more sections of the at least one medical record with at least one body part; associate the one or more sections of the at least one medical record with at least one patient medical condition; determine which of the one or more sections are associated with both the same body part and the same patient medical condition; generate, for each body part and patient medical condition that have two or more sections associated with both the body part and patient medical condition, one or more merged sections comprising the two or more sections associated with both the body part and patient medical condition; generate, for each body part and patient medical condition that have one or more sections associated with both the body part and patient medical condition, one or more merged medical records comprising (i) one or more merged sections comprising two or more sections associated with both the body part and patient medical condition, and (ii) one or more sections associated with both the body part and the patient medical condition if such one or more sections associated with both the body part and the patient medical condition are not part of a merged section; receive a selection of a body part of a body image; and provide, in response to receiving the selection of a body part, one or more merged medical records comprising one or more sections associated with the selected body part.

Consistent with at least one disclosed embodiment, providing merged medical information for a patient whose medical records are stored in one or more locations may also be accomplished with a display displaying a body image; at least one input device; one or more storage media storing computer readable instructions; and one or more processors configured to execute the instructions to cause the system to: provide authorization to access at least one patient medical record associated with a patient; provide an indication, via the at least one input device, of a user selection of a body part of the body image; and receive, in response to the indication, one or more merged medical records comprising (i) if such sections exist, one or more merged medical-record sections comprising two or more sections associated with both the selected body part and a common patient medical condition, and (ii) one or more sections associated with both the body part and the patient medical condition if such one or more sections associated with both the selected body part and the patient medical condition are not part of a merged section.

### BRIEF DESCRIPTION OF THE DRAWINGS

The accompanying drawings, which are incorporated in and constitute part of this specification, and together with the description, illustrate and serve to explain various embodiments.

FIG. 1 illustrates an exemplary system environment wherein the system for providing merged medical information for a patient operates.

FIG. 2 illustrates an exemplary system for providing merged medical information for a patient.

FIG. 3 illustrates an exemplary process for providing merged medical information for a patient whose medical records are stored in one or more locations.

FIG. 4 illustrates an exemplary body image.

FIG. 5 illustrates an exemplary medical information system interface.

FIG. 6 illustrates an exemplary embodiment of a system wherein merged medical records are displayed to the first user.

FIG. 7 illustrates an exemplary system architecture.

It is to be understood that both the foregoing general descriptions and the following detailed descriptions are exemplary and explanatory only and are not restrictive of the claims.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

An electronic health record (EHR) is a digital collection of patient health information compiled at one or more meetings in any care delivery setting. A patient's record typically includes various pieces of information, such as patient demographics, progress notes, problems, medications, vital signs, past medical history, immunizations, laboratory data, and radiology reports. The advantage of using electronic health records over paper-based records is that it facilitates health information exchange. In order to provide better care, right information needs to be available to right people at right time. A fully interoperable infrastructure of coordinated care and communication across health care providers, patients, and public health entities would improve health care quality, lower health care costs, and improve population health. An interoperable health IT ecosystem would support critical public health functions such as real-time disease surveillance and disaster response, and data aggregation for research and value-based payment that rewards higher quality care, not necessarily a higher quantity of care. Such a system may be used by, for example, a medical patient, a healthcare provider, a caregiver, a member of a family, or a government health official.

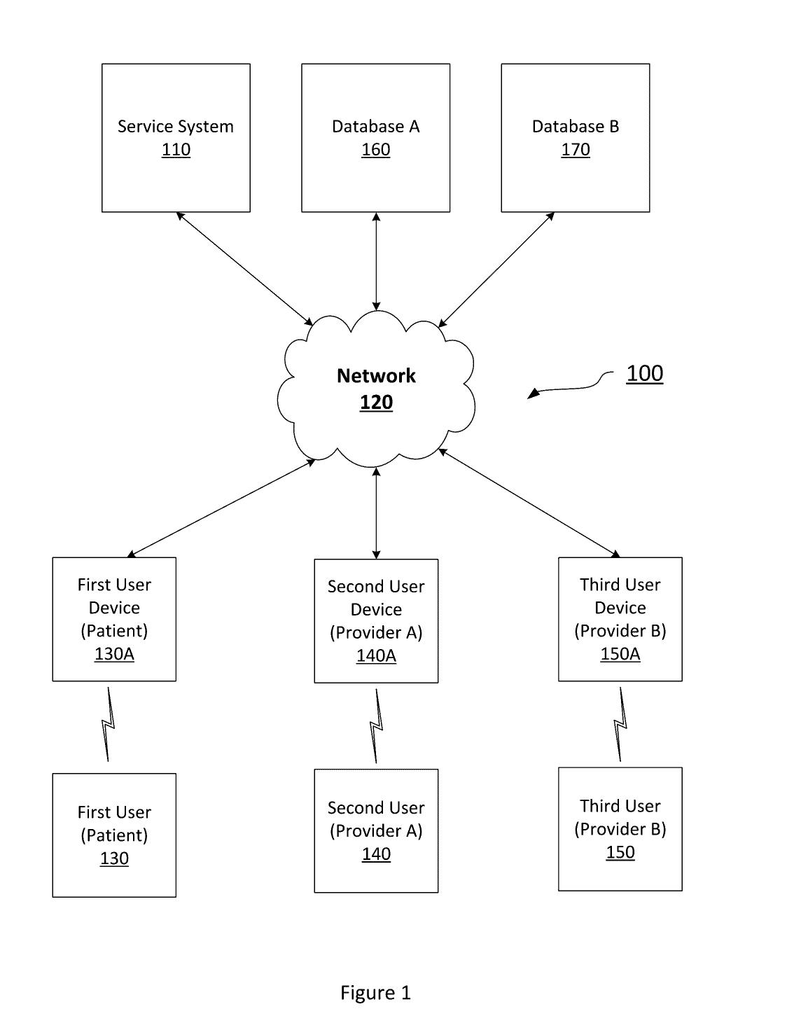

The present disclosure describes systems for merging medical information for a patient whose medical records are stored in one or more locations. Such a system may present users with medical information as a single entity by gathering all their medical information from various sources, such as databases and electronic health portals, allowing them to also access specific portions of their medical history. Such a system may comprise, for example, an internet-based application or service. The system for providing merged medical information for a patient may operate in an environment such as exemplary system environment 100, illustrated in FIG. 1. The environment may comprise a service system 110; a network 120; user devices such as first user device 130A, second user device 140A, and third user device 150A; users such as first user 130, second user 140, and third user 150; and databases such as database 160 and 170. In an exemplary system environment 100, in which embodiments consistent with the present disclosure may be practiced and implemented, includes a system that may include one or more server or service systems 110, databases, and/or computing systems configured to receive information from entities in network 120, process the information, and communicate the information with other entities in the network 120, such as first user 130, second user 140, and third user 150. For example, the system 110 may be configured to receive data over an electronic network 120 (e.g., the Internet), process/analyze queries and data, and provide an application to users 130 and 140. This may be done over devices 130A, 140A, and 150A.

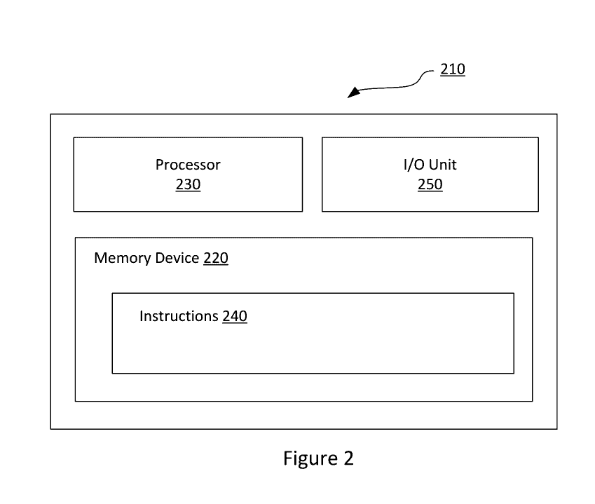

Such a system 210, illustrated in FIG. 2 as an exemplary system for providing merged medical information for a patient, may comprise one or more storage mediums or memory devices such as 220, storing computer readable instructions for merging medical information for a patient whose medical records are stored in one or more locations.

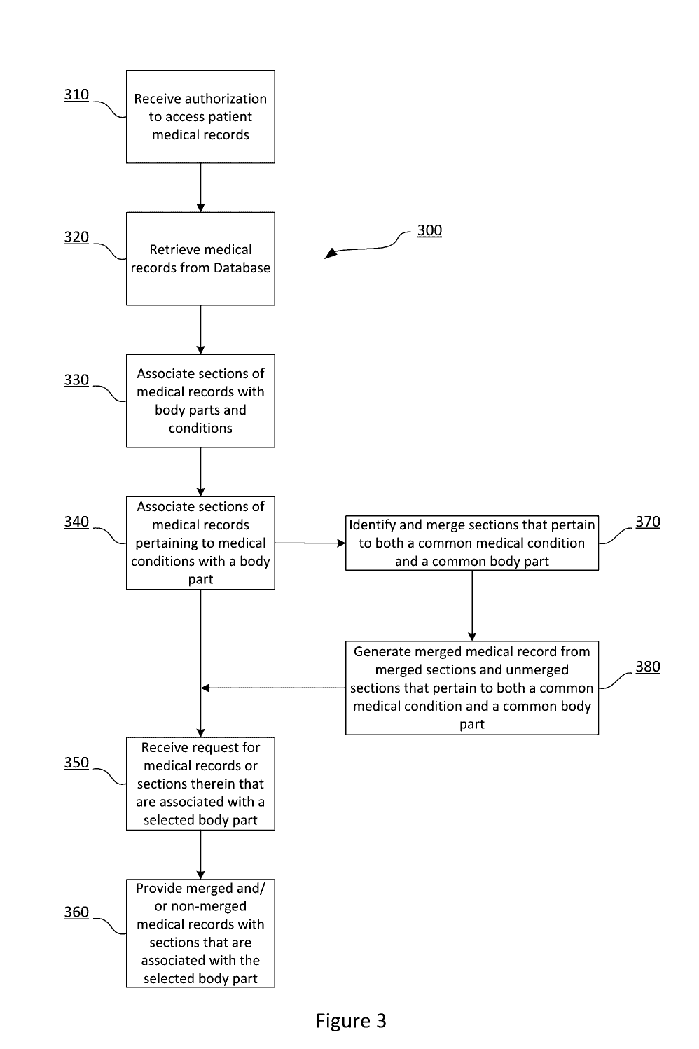

The system 210 of FIG. 2 may also comprise one or more processors 230 configured to execute the instructions 240, wherein execution of the instructions 240 performs an exemplary process, process 300 illustrated in FIG. 3, for providing merged medical information for a patient whose medical records are stored in one or more locations.

The various components of the system 210, illustrated in FIG. 2, may include an assembly of hardware, software, and/or firmware, including a memory 220, a central processing unit (“CPU”), and/or a user interface 250. Memory 220 may include any type of RAM or ROM embodied in a physical storage medium, such as magnetic storage including floppy disk, hard disk, or magnetic tape; semiconductor storage such as solid state disk (SSD) or flash memory; optical disc storage; or magneto-optical disc storage. A CPU may include one or more processors, such as processor 230, for processing data according to a set of programmable instructions 240 or software stored in the memory 220. The functions of each processor 230 may be provided by a single dedicated processor 230 or by a plurality of processors. Moreover, processors may include, without limitation, digital signal processor (DSP) hardware, or any other hardware capable of executing software. An optional user interface may include any type or combination of input/output devices 250, such as a display monitor, keyboard, touch screen, and/or mouse.

As described above, the system 110 of FIG. 1 may be configured to receive data over a network (such as an electronic network), process/analyze queries and data, and provide geographic locations to users. Examples of an electronic network 120 include a local area network (LAN), a wireless LAN (e.g., a “WiFi” network), a wireless Metropolitan Area Network (MAN) that connects multiple wireless LANs, a wide area network (WAN) (e.g., the Internet), and a dial-up connection (e.g., using a V.90 protocol or a V.92 protocol). In the embodiments described herein, the Internet may include any publicly-accessible network or networks interconnected via one or more communication protocols, including, but not limited to, hypertext transfer protocol (HTTP) and transmission control protocol/internet protocol (TCP/IP). Moreover, the electronic network may also include one or more mobile device networks, such as a GSM network or a PCS network, that allow mobile devices, such as a first, second, and third user device 130A, 140A, and 150A to send and receive data via applicable communications protocols, including those described above. Further, the system may operate and/or interact with one or more host servers, one or more user devices for the purpose of implementing features described herein.

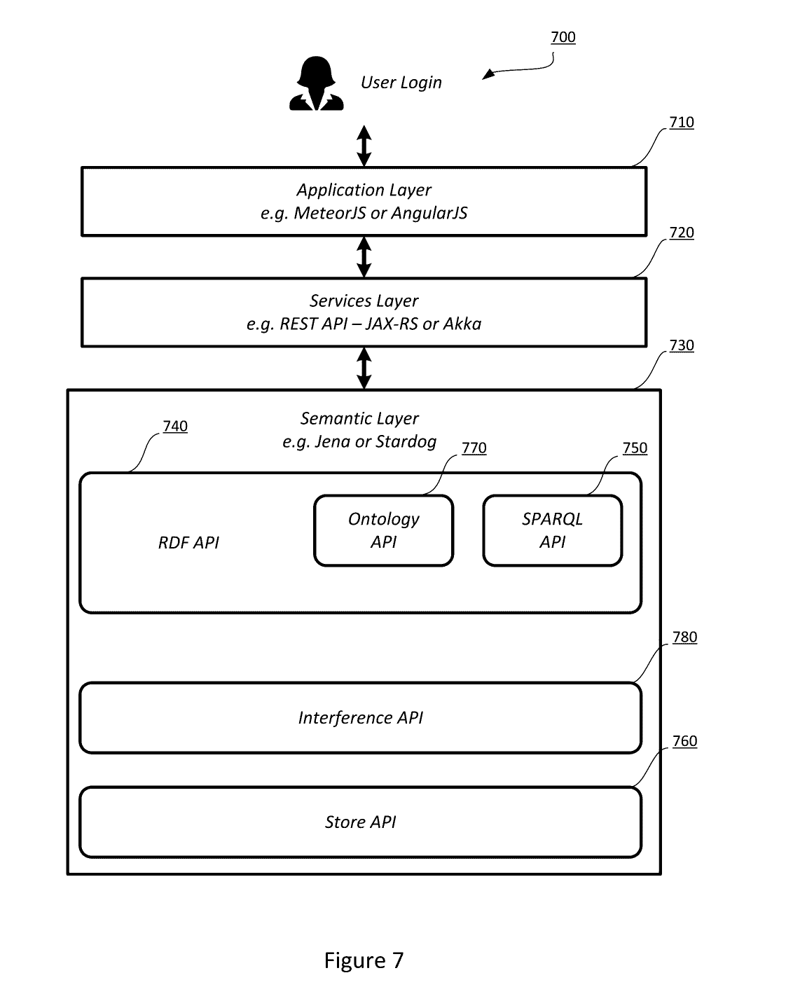

System 110 of FIG. 1 may have an architecture such as exemplary architecture 700 of FIG. 7. Exemplary architecture 700 may include the following layers:

(1) Application Layer 710: This layer serves as the point of entry for users to interact with the system. The Application Layer provides a login mechanism to allow authorized users to enter the system with their unique username and password. After a user has logged in, the system retrieves the user's medical information, which may be spread across various databases. The system allows the user to query and/or merge different pieces of information from the aggregated medical records. Some sample technologies that can be used to implement this layer include MeteorJS and AngularJS.

(2) Services Layer 720: This layer serves as a facilitator for passing user-initiated instructions, such as queries or merge instructions, to the underlying Semantic Layer 730, and for relaying back query results to the Application Layer for consumption by the user. Some sample technologies that can be used to implement this layer include JAX-RS and Akka.

(3) Semantic Layer 560: This layer stores a user's aggregated data using the RDF data model in a Semantic Web framework such as Jena or Stardog. At a high-level, these frameworks comprise the following components: (a) the Resource Description Framework (RDF) API 740 allows an application to create RDF graphs, store RDF triples in them and find RDF triples that match a given pattern using a high-level, user-friendly programming interface. The SPARQL API 750 allows an application to query/update RDF graphs using the SPARQL query language. The Ontology API 770 provides functions that operate over the richer semantic constructs provided by the RDF Schema and the W3C Web Ontology (OWL) languages. The Inference API 780 provides a means to compute and store inferences in an RDF triple store. The Store API 760 converts user operations defined in the RDF API into low-level, implementation-specific operations on RDF graphs. A Semantic Web framework usually supports several ways to store RDF graphs including, in-memory, SQL databases, custom disk-based tuple indexes, etc. These frameworks also provide a point for users to plug in their own custom storage solutions. The Resource Description Framework (RDF) is a component of the Semantic Web stack. RDF is a graph data model which was primarily designed to facilitate data integration and data distribution on Semantic Web. The fundamental data structure used by RDF is a Triple or a Statement. A triple comprises three parts, namely a subject, predicate and an object. A triple essentially states that the subject resource is related to the object resource via the predicate (aka property or relationship). A set of such triples comprises an RDF graph. The flexibility of RDF is mainly due to the triple data structure. An RDF graph is a graph comprising a set of resources in the form of nodes and relationships/edges/links between the nodes. A resource is represented using a URI that uniquely identifies the resource. While merging RDF graphs from two or more sources, two resources may be treated as being the same if they have the same URI's.

At step 310 of process 300 in FIG. 3, the instructions 240 executed by the one or more processors 230 cause the system to receive authorization to access one or more patient medical records. The authorization may be received from one or more of user devices 130A, 140A, and 150A. The authorization may be granted by a first user 130, such as a patient, seeking to gain access to their medical records. The system may allow for a single authentication process to provide authorization to retrieve medical records from databases 160 and 170 that may each be managed by different or multiple Health IT systems or organizations. Such single authentication process may require a first user 130 to provide all authentication information necessary to access the various databases 160 and 170. This authentication information may be saved then reused in subsequent sessions without needing to be reentered. The system may allow for secure data management by not storing protected health information between user sessions and instead retrieving medical records on-demand. If the first user 130 is accessing another's medical records, such as a caregiver or head of a household or family member accessing medical records for someone relying on the first user 130 for healthcare, a separate authorization system or account may be used to manage the privileges associated with the first user 130. In certain account relationships, medical records and information can be merged or exchanged between accounts.

At step 320, the instructions 240 executed by the one or more processors 230 cause the system to retrieve medical records from one or more of databases 160 and 170. The medical records may comply with a particular or group of architectures, such as a consolidated clinical document architecture (C-CDA) template standardized by Health Level Seven International (HL7). Examples of such templates may include, but are not limited to, Continuity of Care Document, Consultation Note, Diagnostic Imaging Report, Discharge Summary, History and Physical, Operative Note, Procedure Note, Progress Note, and Unstructured Document. C-CDA is an XML-based markup standard for specifying encoding, structure, and semantics of clinical documents.

Databases 160 and 170, from which the medical records may be retrieved, may be associated with healthcare institutions. For example, second user 140 may be a healthcare provider (Provider A) operating on a second user device 140A, such as a computer managed by a healthcare institution. The medical records retrieved at step 320 may be created or edited by Provider A 140, and may be stored locally on Provider A's device—second user device 140A—or may be stored in one or more databases 160 and 170. Alternatively or in addition, a third user 150 may be another healthcare provider (Provider B) operating on a third user device 150A, such as a computer managed by another healthcare institution. System 100 may be set up so that database 160 is used exclusively by second user 140 and database 170 is used exclusively by third user 150. The medical records retrieved at step 320 may come from any combination of the databases 160 and 170 and may have originated at any combination of healthcare providers, such as second user 140 and third user 150.

At step 330, the instructions 240 executed by the one or more processors 230 cause the system to associate sections of medical records with body parts and conditions. This process may include data-extraction techniques such as screen scraping the C-CDA compliant medical records and storing the extracted data in a markup language such as Hypertext Markup Language (HTML) or XML. The information may then be organized in a manner that complies with a particular data model, such as Resource Description Framework (RDF) triples, specified by the World Wide Web Consortium. Organization may occur according to a semantic ontology, such as the C-CDA Ontology, though other ontologies may be used instead or in addition to C-CDA. Specifically, each individual medical record may have its information transformed from markup-language form into a named graph of RDF triples using the C-CDA Ontology. Such ontology may contain schema information, such as RDF Schema or OWL constructs, that may be used to convert information from the particular type of C-CDA template implemented by the document to RDF triples. Alternatively, or in addition, the same can be accomplished manually by using a MongoDB schema which captures the semantic relations expressed in the ontology in an offline manner. The schema information may comprise an ontology or a combination of ontologies reflecting a mapping between body parts and medical conditions. In certain embodiments, this schema information may be constructed to reflect a mapping without reliance on a semantic ontology.

At step 340, the instructions 240 executed by the one or more processors 230 cause the system to associate sections of medical records pertaining to medical conditions with a body part. The sections of the medical records may comport to certain templates, such as those specified in the C-CDA standard. An association may be created if, for example, a section within a medical record has information pertaining to a certain body part or a medical condition that may affect the particular body part. This association may be done by assigning a digital tag or other metadata structure to the sections. Multiple tags may be assigned to the section. Alternatively or in addition, the entire medical record may be associated with a body part if the medical record has sections with information pertaining to a medical condition. Alternatively or in addition, the entire medical record may be associated with a body part regardless of whether the medical record has information pertaining to a medical condition. Alternatively or in addition, the entire medical record may be associated with a medical condition regardless of whether the medical record has information pertaining to a body part. In certain embodiments, the entire medical record may be associated with a medical condition and/or by parsing the information within the medical record without regard to what sections are and are not contained within the medical record.

In certain embodiments, the system may determine whether the medical record has information pertaining to a medical condition and then determine itself whether the medical condition is inherently associated with a body part. This may be done, for example, by relying on a mapping between diseases and conditions and other ontologies (such as a mapping between the International Classifications of Diseases, version 10 and the Systemized Nomenclature of Medicine). The mapping may be between medical conditions and body parts. It will be appreciated by one of skill in the art that the structures representing the medical conditions and body parts may be concepts within a semantic ontology that may internally comprise or link to other associated medical conditions and/or body parts. In the case of body parts, for example, the body image may comprise an interconnection of body parts which themselves comprise other body parts and may be navigated at the user 130's request to reach a particular level of specificity or detail within the body image. The medical record's sections may be analyzed for content using a markup language parser, such as an HTML parser or an XML parser.

At step 350, the instructions 240 executed by the one or more processors 230 cause the system to receive a request for medical records or sections therein that are associated with a selected body part. Such request may be received from first user 130. The user may select a body part by selecting a body part on a displayed body image. The selection may comprise clicking on a body part on the body image or hovering a cursor over a body part on the body image. The selection may create a SPARQL query.

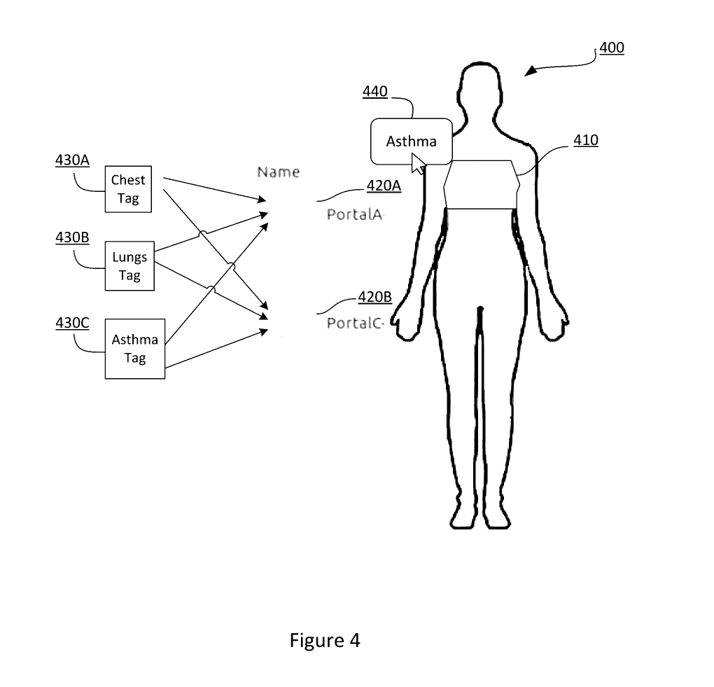

In certain embodiments, the exemplary body image 400 of FIG. 4 may distinguish for the first user 130 which body parts the first user 130 may select. This distinguishing may be done by, for example, shading selectable body parts, such as exemplary selectable body part 410, such as the chest or lungs, in a different color than non-selectable body parts. In certain embodiments, the system may make selectable only those body parts that have medical records associated with them. The system may determine whether each medical record, shown in FIG. 4 as exemplary medical record 420A and 420B, has a body part associated with it by checking, for example, if there is a tag, such as exemplary tags 430A, 430B, and 430C, or other metadata structure associated with the medical record. Alternatively, the system may make body parts selectable regardless of whether they have medical records associated with them. The system may indicate to the first user 130 whether there are medical records associated with a body part by, for example, displaying a visual indicator, such as a message, when the first user 130 uses input device 250, such as a mouse, to place their cursor over the body part or select the body part. In addition, or alternatively, the system may display a list of medical conditions, such as exemplary medical-condition display 440, that are associated with sections in medical records that are associated with the selected body part. The system may then display the medical records associated with a particular medical condition—medical records 420A and 420B—when the user selects the particular medical condition, 440. In addition or alternatively, the system may display the medical records 420A and 420B when the user selects the body part 410 with one or more tags 430A, 430B, and 430C associated with the medical records 420A and 420B. It will be understood that displaying medical records may comprise displaying abstract representations of the records, such as icons, which may be selected by the first user 130 to show the content of the medical record associated with the icon the user selected. In certain embodiments, selecting an icon may allow the first user 130 to preview the content of a document by displaying it within a web browser or another software without requiring the first user 130 to view the medical record within the software typically intended for viewing such content. It will also be understood that displaying the medical records may comprise displaying the content of the medical records.

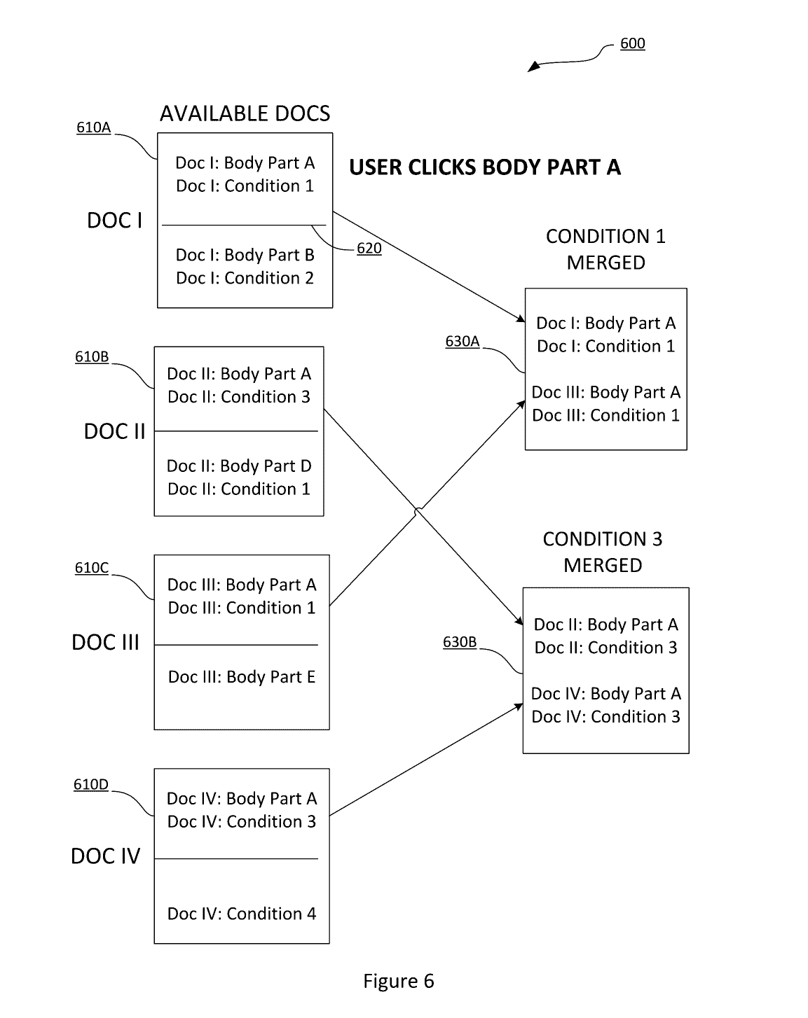

FIG. 6 provides an illustrative example of an exemplary embodiment 600 of a system wherein merged medical records are displayed to the first user 130. The system, at step 320 of process 300, may retrieve four medical records from one or more databases 160 and 170: medical records 610A (Doc I), 610B (Doc II), 610C (Doc III), and 610D (Doc IV). Each medical record may have, for example two sections, as indicated by the exemplary illustrative divider 620. Each section may have at least one body part and at least one medical condition associated with it. Some sections, however may have no medical condition or no body part associated with it. The system may then generate merged documents that comprise merged sections, wherein each merged section within a merged document pertains to both the same medical condition and the same body part. For example, the top section of medical record 610A may be merged with the top section of medical record 610C because they are both associated with body part A and medical condition 1. Merged sections can be consolidated into merged documents or merged medical records 630A and 630B. In certain embodiments, it may be sufficient that the medical records pertain to the same medical condition for them to be merged, or it may be sufficient that the medical records pertain to the same body part for them to be merged. In the exemplary embodiment 600, once all sections that pertain to both the same medical condition and the same body part are merged, the first user 130 may select a body part that has medical records or merged documents associated with it. In certain embodiments, if the first user 130 selects body part A, the system may display condition 1 and condition 3 to the user for selection, since these are the two conditions for which there are medical-record sections associated with body part A. The user may then select, for example, condition 1, and view the content of a merged document comprising merged sections pertaining to both body part A and condition 1—namely the upper section of Doc I (610A) and the upper section of Doc III (310C). Alternatively, or in addition, the user may be presented with all medical records with sections containing information about medical conditions pertaining to the selected body part.

At step 360, the instructions 240 executed by the one or more processors 230 cause the system to provide non-merged medical records with sections that are associated with the selected body part, or, if sections within the medical records were merged as described in preceding sections of this disclosure, provide merged medical records with merged sections associated with the selected body part. Alternatively, or in addition, the medical records provided may be non-merged regardless of whether sections within the medical records were merged.

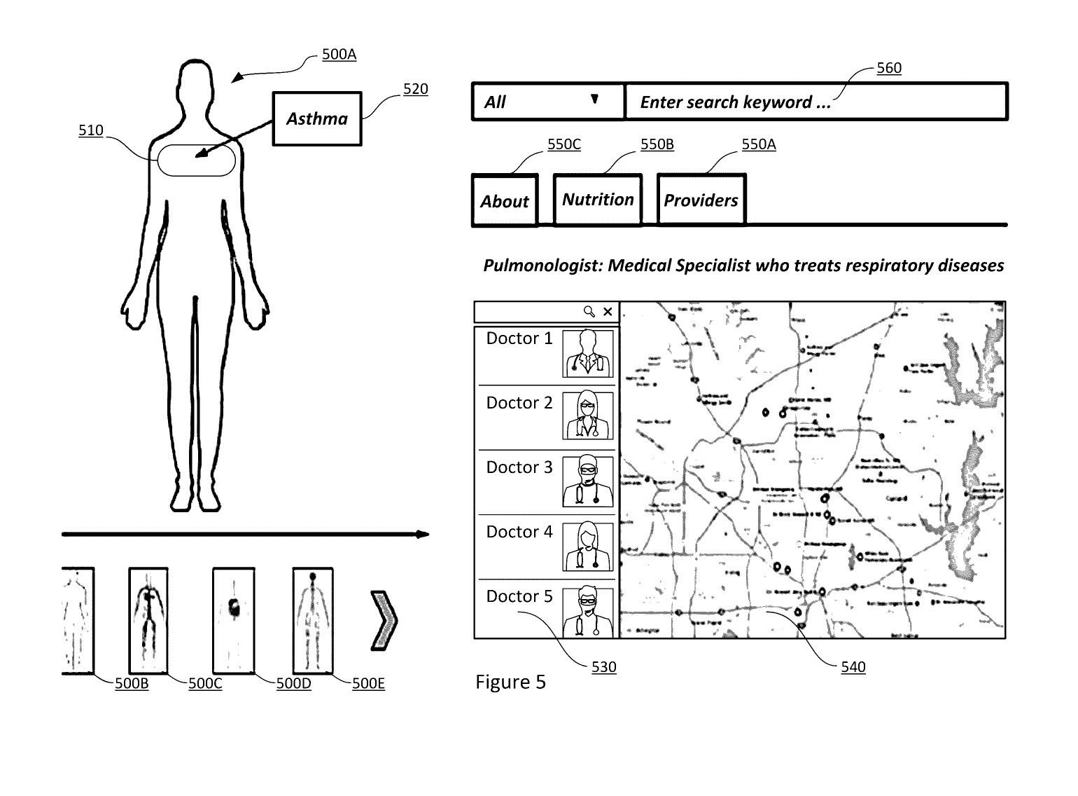

Alternatively, or in addition, in certain embodiments the system may provide information medically pertinent to the selected body part. This medically pertinent information may include, but is not limited to, information about providers who treat conditions relating to the selected body part; prophylactic information or other preventative information that helps patients avoid problems with the selected body part; medical treatments; homeopathic treatments for selected body part ailments; nutritional information to maintain or improve functioning of the selected body parts; food-related information that describes various foods that provide the necessary nutrients related with the conditions relating to the selected body part; symptoms and supplement information for the conditions relating to the selected body part; user discussions and comments for the conditions or other topics of interest relating to the selected body part; exercise information to increase strength and/or endurance of the selected body part; or medical literature associated with the body part or conditions affecting the body part. In addition or alternatively, an Internet hyperlink to the information may be provided. The requested information may be collected from publically and/or privately available sources, such as webpages on the World Wide Web. In certain embodiments, the information provided may comprise the pricing and availability of products in various marketplaces that pertain to the selected body part. This information may comprise, for example, supplement price comparisons from different dealers, wherein the supplements are those that pertain to the body part (e.g., vitamin A supplements if the selected body part is the eyes). The information may comprise, for example, books or other literature for sale and the prices associated therewith at different online or brick-and-mortar dealers and merchants. The information provided to the first user 130 may also be merged by subject matter, such as merging sections relating to the selected body part but appearing in different medical reports into a single document. In certain embodiments, the specific information displayed or linked to may be chosen based on information contained within the medical records. For example, if a patient's medical records have sections pertaining to obesity or tags associating the medical condition of obesity with the medical records or the sections therein, selecting the abdomen on the body image may present information pertaining to nutrition and exercise, whereas if the patient's medical records have sections pertaining to pregnancy, selecting the abdomen may give information relevant to pregnant women. In an exemplary embodiment of a medical information system interface, illustrated in FIG. 5, the first user 130 may select a body part 510 on a body image 500A, and, in certain embodiments, select a medical condition 520 associated with the selected body part 510. Doing so may cause the system to display information pertaining to the selected medical condition and/or the selected body part. Such information may include a list of healthcare providers 530 that specialize in the medical condition or body part. In certain embodiments, the system may arrange the healthcare provider list 530 by proximity to the first user 130 and provide a map 540 showing the user 130 the locations of the listed healthcare providers. In certain embodiments, there may be more than one body image—such as body images 500B, 500C, 500D, and 500E—and the system may display different kinds of information depending on which body image the user selects a body part on. These body images may be arranged along a horizontal axis and arranged in any order, including, but not limited to, having the outermost parts of the body on the left side of the axis and the innermost parts of the body on the right side of the axis. Alternatively, or in addition, the user may select the sort of information they want to view before selecting a body part on the body image. For example, the first user 130 may select a digital button 550A if they want healthcare provider information associated with the selected body part or medical condition pertaining thereto, digital button 550B if they want nutritional information associated with the selected body part or medical condition pertaining thereto, or 550C if they want medical information associated with the selected body part or medical condition pertaining thereto. In certain embodiments, the first user 130 may select any combination of such digital buttons. In certain embodiments, the buttons for selecting the type of information to display may be displayed on a vertical axis. Such axis can have the options presented thereon change depending on which type or types of information were previously selected by the first user 130. While in certain embodiments the types of information may be displayed in any order along the vertical axis, in certain other embodiments the types of information may be presented on the vertical axis according to some logical order (e.g., the types of information most pertinent to the medical health of the first user 130 may be at the top of the vertical axis, and types of information that would be for the first user's 130 edification would be at the bottom of the vertical axis). The types of information the first user may select on the vertical axis and the type of body image the user may select on the horizontal axis may be determined by medical information stored regarding the first user 130. Additionally, or alternatively, first user 130 may search for the information they seek by typing search terms into search bar 560. The search term may be entered in lieu or in addition to selecting a body part on the body image. It will be appreciated by one of skill in the art that the various types of information may be associated with each other according to a particular mapping, and that such mapping may evolve over time when, for example, new medical research discovers novel associations between certain information and certain body parts. In certain embodiments, the first user's 130 selections or other interactions with the system may determine what information is presented to the first user 130 and in what manner it is presented. In certain embodiments, a selection on the vertical axis may change the selection options on the horizontal access and vice versa.

At optional step 370, optionally following step 340, the instructions 240 executed by the one or more processors 230 cause the system to identify and merge sections that pertain to both a common medical condition and a common body part. This may require first determining if there is more than one medical record section that is associated with both the same body part and the same patient medical condition. If so, these sections may be merged. In addition, or alternatively, sections may be merged if they are associated with a common body part. In addition, or alternatively, sections may be merged if they are associated with a common patient medical condition. To facilitate the identification of sections for merging and performing the actual merge, a query language can be used to retrieve and manipulate the necessary metadata, such as that stored in RDF triples. For example, a SPARQL Protocol and RDF Query Language query may be used.

At optional step 380, optionally following optional step 370, the instructions 240 executed by the one or more processors 230 cause the system to generate merged medical records from merged sections and unmerged sections that pertain to both a common medical condition and a common body part. In some embodiments, these merged sections may be placed consecutively in a new document. In some embodiments, sections that were not merged may be added at the end, beginning, or another part of a newly-created document with merged sections. In addition, or alternatively, the system may generate merged medical records from merged sections and/or unmerged sections that pertain to a common medical condition. In addition or alternatively, the system may generate merged medical records from merged sections and/or unmerged sections that pertain to a common body part. In certain embodiments, information comprising a merged document's history may be created. The document's history may comprise information describing when the document was produced, what system the document was produced with, what documents the merged sections originated from, and other information describing the merged document's history, formation, and pedigree. Such document history may be embedded, associated, or both with the merged document.

The systems and methods described above may be implemented by any hardware, software, or a combination of hardware and software having the above-described functions. The software code, either in its entirety or a part thereof, may be stored in a computer readable memory.

While several implementations have been provided in the present disclosure, it should be understood that the disclosed systems and methods may be implemented in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems, and methods described and illustrated in the various implementations as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

While the above detailed description has shown, described, and pointed out the fundamental novel features of the disclosure as applied to various implementations, it will be understood that various omissions and substitutions and changes in the form and details of the system illustrated may be made by those skilled in the art, without departing from the intent of the disclosure.

What is claimed is:

1. A system for providing merged medical information for a patient whose medical records are stored in one or more locations, the system comprising:
one or more storage media storing computer readable instructions; and
one or more processors configured to execute the instructions to cause the system to:
receive authorization to access at least one medical record associated with a patient;
retrieve, based on the authorization, the at least one medical record from at least one database, wherein the at least one medical record comprises one or more sections;
associate the one or more sections of the at least one medical record with at least one body part;
associate the one or more sections of the at least one medical record with at least one patient medical condition;
determine which of the one or more sections are associated with both the same body part and the same patient medical condition;
generate, for each body part and patient medical condition that have two or more sections associated with both the body part and patient medical condition, one or more merged sections comprising the two or more sections associated with both the body part and patient medical condition;
generate, for each body part and patient medical condition that have one or more sections associated with both the body part and patient medical condition, one or more merged medical records comprising (i) one or more merged sections comprising two or more sections associated with both the body part and patient medical condition, and (ii) one or more sections associated with both the body part and the patient medical condition if such one or more sections associated with both the body part and the patient medical condition are not part of a merged section;
receive a selection of a body part of a body image; and
provide, in response to receiving the selection of a body part, one or more merged medical records comprising one or more sections associated with the selected body part.

2. The system of claim 1, further comprising converting the at least one patient medical record to Resource Description Framework triples according to a C-CDA Ontology.

3. The system of claim 2, wherein the C-CDA Ontology contains schema information.

4. The system of claim 3, wherein the schema information reflects one or more ontologies comprising a mapping between body parts and medical conditions.

5. The system of claim 1, wherein the authorization is received from a first user system.

6. The system of claim 1, wherein the database is associated with a first healthcare institution.

7. The system of claim 1, wherein the at least one patient medical record complies with a consolidated clinical document architecture (C-CDA) template.

8. The system of claim 1, wherein the received selection is a SPARQL Protocol and RDF Query Language query.

9. The system of claim 1, wherein the received selection is a MongoDB query.

10. A system for providing merged medical information for a patient whose medical records are stored in one or more locations, the system comprising:
a display displaying a body image;
at least one input device;
one or more storage media storing computer readable instructions; and
one or more processors configured to execute the instructions to cause the system to:
provide authorization to access at least one patient medical record associated with a patient;
provide an indication, via the at least one input device, of a user selection of a body part of the body image; and
receive, in response to the indication, one or more merged medical records comprising (i) if such sections exist, one or more merged medical-record sections comprising two or more sections associated with both the selected body part and a common patient medical condition, and (ii) one or more sections associated with both the body part and the patient medical condition if such one or more sections associated with both the selected body part and the patient medical condition are not part of a merged section.

11. The system of claim 10, wherein the one or more merged medical records comprise information stored in Resource Description Framework triples according to a C-CDA Ontology.

12. The system of claim 11, wherein the C-CDA Ontology contains schema information.

13. The system of claim 12, wherein the schema information is an ontology or a combination of ontologies reflecting a mapping between body parts and medical conditions.

14. The system of claim 10, wherein the authorization is provided to a service system.

15. The system of claim 10, wherein the authorization comprises authorization to retrieve, based on the authorization, the at least one medical record from at least one database.

16. The system of claim 15, wherein the database is associated with a first healthcare institution.

17. The system of claim 10, wherein the at least one patient medical record comprises one or more sections.

18. The system of claim 10, wherein the at least one patient medical record complies with a consolidated clinical document architecture (C-CDA) template.

19. The system of claim 10, wherein the indication is a SPARQL Protocol and RDF Query Language query.

20. The system of claim 10, wherein the indication is a MongoDB query.
